(19) United States
(12) Patent Application Publication
(10) Pub. No.: US 2026/0055788 A1
(43) Pub. Date: Feb. 26, 2026

(54) CLAMPING ASSEMBLY AND METHOD FOR INSTALLING AN ACCESSORY ON A CONNECTING INTERFACE

(71) Applicant: SOUCY INTERNATIONAL INC., Drummondville (CA)

(72) Inventors: Dominique BOUDREAU, Quebec (CA); Frederik BESSETTE, Beloeil (CA); Jean-Michel LECLERC, Drummondville (CA); Alexandre POUDRIER, Drummondville (CA)

(21) Appl. No.: 19/297,585

(22) Filed: Aug. 12, 2025

Related U.S. Application Data
(60) Provisional application No. 63/684,964, filed on Aug. 20, 2024.

(51) Int. Cl. F16B 21/02

(52) U.S. Cl. CPC F16B 21/02

(57) ABSTRACT

A clamping assembly includes a housing, at least one clamping member partially is received in the housing, a guiding member operatively engaged to the at least one clamping member, a biasing member and an actuating member. The at least one clamping member partially is received in the housing, and is moveable between extended and retracted positions. The guiding member is rotatable about a rotation axis between first and second guide positions. The biasing member biases the guiding member toward the first guide position. The actuating member is configured to operatively engage the guiding member in a first configuration, in which the actuating member is rotatable about the rotation axis between a first rotational position and a second rotational position, and a second configuration in which the actuating member is prevented from rotating relative to the rotation axis. The clamping assembly is moveable between clamped and unclamped states.

### CROSS-REFERENCE TO RELATED APPLICATION

This application claims the benefit of and priority to U.S. provisional patent application No. 63/684,964 , filed on Aug. 20, 2024; the content of all of which is herein incorporated in entirety by reference.

### TECHNICAL FIELD

The present technology relates to clamping assemblies and to methods for installing accessories to connecting interfaces using the clamping assemblies.

### BACKGROUND

Clamping assemblies are used to couple one or more accessories to connecting interfaces. In some instances, the connecting interfaces may be disposed on vehicles for coupling accessories to said vehicles.

Conventional clamping assemblies are generally “size specific”, (i.e., configured to connect to a connecting interface having a given size). This can be problematic when there is a desire for connecting the clamping assembly to different connecting interfaces having different sizes.

Additionally, connecting and/or disconnecting conventional clamping assemblies to and/or from connecting interfaces can be time consuming, and can sometimes require tools for installing and/or removing fasteners.

Therefore, there is a desire for a device that can mitigate the above-mentioned issues.

### SUMMARY

It is an object of the present technology to ameliorate at least some of the inconveniences present in the prior art.

According to one aspect of the present technology, there is provided a clamping assembly. The clamping assembly includes a housing, at least one clamping member, a guiding member, a biasing member and an actuating member. The housing defines an opening and has a clamping surface. The at least one clamping member is partially received in the housing, and the at least one clamping member is moveable between an extended position, in which part of the at least one clamping member extends from the opening, and a retracted position, in which the part of the at least one clamping member is received in the housing. The guiding member is operatively engaged to the at least one clamping member. The guiding member is rotatable about a rotation axis between a first guide position, in which the at least one clamping member is in the extended position, and a second guide position, in which the at least one clamping member is in the retracted position. The biasing member is for biasing the guiding member toward the first guide position. The actuating member is at least partially disposed in the housing, and is configured to operatively engage the guiding member in a first configuration, in which the actuating member is rotatable about the rotation axis between a first rotational position and a second rotational position, and a second configuration in which the actuating member is prevented from rotating relative to the rotation axis. With the actuating member in the first configuration, in response to the actuating member rotating between the first rotational position and the second rotational position, the operational engagement between the actuating member and the guiding member causes the guiding member to rotate between the first guide position and the second guide position. With the actuating member in the second configuration, the guiding member is prevented from rotating relative to the rotation axis, and the clamping assembly is moveable between a clamped state and an unclamped state. In the clamped state, the actuating member is in the first configuration, and in the first rotational position, the guiding member is in the first guide position; and the at least one clamping member is the extended position, and the clamping assembly is configured to clamp onto a connecting interface by the clamping surface of the housing and the at least one clamping member. In the unclamped state, the actuating member is in the second configuration, the guiding member is in the second guide position, and the at least one clamping member is in the retracted position.

In some embodiments, the clamping assembly is configured to move from the unclamped sate to the clamped state automatically.

In some embodiments, the clamping assembly is further moveable to an intermediate clamped state, in which the actuating member is in the first configuration, and in a third rotational position, the third position being intermediate to the first and second rotational positions; the guiding member is in a third guide position, the third guide position being intermediate to the first and second guide positions; and the at least one clamping member is in an intermediate position, the intermediate position being intermediate to the extended and retracted positions. The clamping assembly is configured to clamp onto the connecting interface between the clamping surface of the housing and the at least one clamping member.

In some embodiments, the clamping assembly is configured to move from the unclamped state to the intermediate clamped state automatically.

In some embodiments, the actuating member includes a handle portion, a position of the actuating member being adjustable via the handle portion.

In some embodiments, the housing includes an upper housing portion at least partially receiving the guiding member and the actuating member, and a lower housing portion defining the opening and at least partially receiving the at least one clamping member.

In some embodiments, the housing has a guiding portion engaged with the at least one clamping member for guiding a movement of the at least one clamping member between the retracted and extended positions.

In some embodiments, the at least one clamping member defines an aperture configured to receive the guiding portion.

In some embodiments, the guiding portion is a cylindrical member.

In some embodiments, the at least one clamping member moves between the extended and retracted positions along a linear path.

In some embodiments, the at least one clamping member has a tapered clamping portion.

In some embodiments, the at least one clamping member has a clamping engager, and the guiding member defines a slot sized to receive the clamping engager.

In some embodiments, with the at least one clamping member being in the extended position, and the guiding member being in the first guide position, the clamping engager is disposed at a radially inner end of the slot, and with the at least one clamping member being in the retracted position, and the clamp guiding member being in the second guide position, the clamping engager is disposed at a radially outer end of the slot.

In some embodiments, the slot is arcuate.

In some embodiments, the slot is arcuate about a point offset from the rotation axis.

In some embodiments, the slot defines a first retaining recess and a second retaining recess, the first and second retaining recesses being configured to at least partially receive the clamping engager therein for preventing movement of the at least one clamping member toward the retracted position in response to an external force being applied on the at least one clamping member. With the guiding member being in the first guide position, the clamping engager is received in the first retaining recess. With the guiding member being in the second guide position, the clamping engager is received in the second retaining recess.

In some embodiments, the guiding member is a cam.

In some embodiments, the guiding member has a guide engaging portion and the actuating member has an actuating engaging portion. In response to the guiding member moving from the first rotational position to the second rotational position, the guide engaging portion engages the actuating engaging portion for causing the guiding member to move from the first guide position to the second guide position.

In some embodiments, with the guiding member being in the first guide position, the actuating member being in the first rotational position, the guide and actuating engaging portions are rotationally spaced from one another for providing some play between rotation of the actuating member, and rotation of the actuating member.

In some embodiments, the biasing member is operatively connected to housing and to the guiding member.

In some embodiments, the biasing member is a torsional spring.

In some embodiments, the biasing member is a first biasing member, and the clamping assembly further includes a second biasing member operatively connected to the actuating member for biasing the actuating member toward the second configuration.

In some embodiments, the actuating member is moveable between the first and second configurations by moving along the rotation axis.

In some embodiments, the actuating member is moveable along the rotation axis by an external axial force.

In some embodiments, in the first configuration, the actuating member is in a lowered position with respect to the housing, and in the second configuration, the actuating member is in a raised position with respect to the housing.

In some embodiments, the actuating member is selectively moveable between the first and second configurations while the actuating member is in the second rotational position.

In some embodiments, the at least one clamping member includes a first clamping member and a second clamping member.

In some embodiments, the first and second clamping members are aligned with one another.

In some embodiments, the clamping assembly further includes a resilient membrane disposed between the connecting interface and the clamping surface.

In some embodiments, the resilient membrane is made of polymeric material.

In some embodiments, the connecting interface defines an aperture, the aperture being one of a vehicle aperture, an accessory aperture, and a mounting bracket aperture.

In some embodiments, the aperture is shaped to receive part of the housing therein.

In some embodiments, the clamping assembly is configured to automatically clamp to a first connecting interface having a first thickness, and a second connecting interface having a second thickness, the first and second thicknesses being different from one another.

In some embodiments, the clamping assembly further includes an accessory connected to the housing.

In some embodiments, the accessory is integral with the housing.

In some embodiments, the accessory is selectively connected to the housing.

In some embodiments, the accessory is one of a gas tank, a light fixture, and a toolbox.

According to another aspect of the present technology, there is provided a method for installing an accessory on a connecting interface. The method includes moving the clamping assembly according to the above aspect or according to the above aspect and one or more of the above embodiments to the unclamped state, inserting part of the clamping assembly into the aperture of the connecting interface, and moving the clamping assembly to the clamped state for clamping onto the connecting interface.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, front, left side of a clamping assembly according to an embodiment of the present technology, with the clamping assembly being in a clamped state;

FIG. 2 is a front elevation view of the clamping assembly of FIG. 1;

FIG. 3 is a perspective view taken from a top, front, left side of the clamping assembly of FIG. 1, with the clamping assembly being in an unclamped state;

FIG. 4 is a front elevation view of the clamping assembly of FIG. 3;

FIG. 5 is an exploded perspective view of the clamping assembly of FIG. 3;

FIG. 6 is a cross-sectional view of the clamping assembly of FIG. 1 taken along a lateral center plane of the clamping assembly;

FIG. 7 is a cross-sectional view of the clamping assembly of FIG. 3 taken along a lateral center plane of the clamping assembly;

FIGS. 8 to 10 are perspective views taken from a bottom, front, right side of an upper housing portion and an actuating portion of the clamping assembly of FIG. 1, with the actuating portion being in various positions relative to the upper housing portion;

FIG. 11 is a perspective view taken from a top, front, right side of part of the clamping assembly of FIG. 1;

FIGS. 12 to 15 are top plan views of a guiding member and a clamping member of the clamping assembly of FIG. 1, with the guide and clamping members being shown in various positions;

FIG. 16 is a front elevation view of the clamping assembly of FIG. 1 clamped to a connecting interface;

FIG. 17 is a front elevation view of the clamping assembly of FIG. 1 clamped to another connecting interface; and

FIG. 18 is a flowchart illustrating a method for installing an accessory on a connecting interface with the clamping assembly of FIG. 1.

### DESCRIPTION OF EMBODIMENTS

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

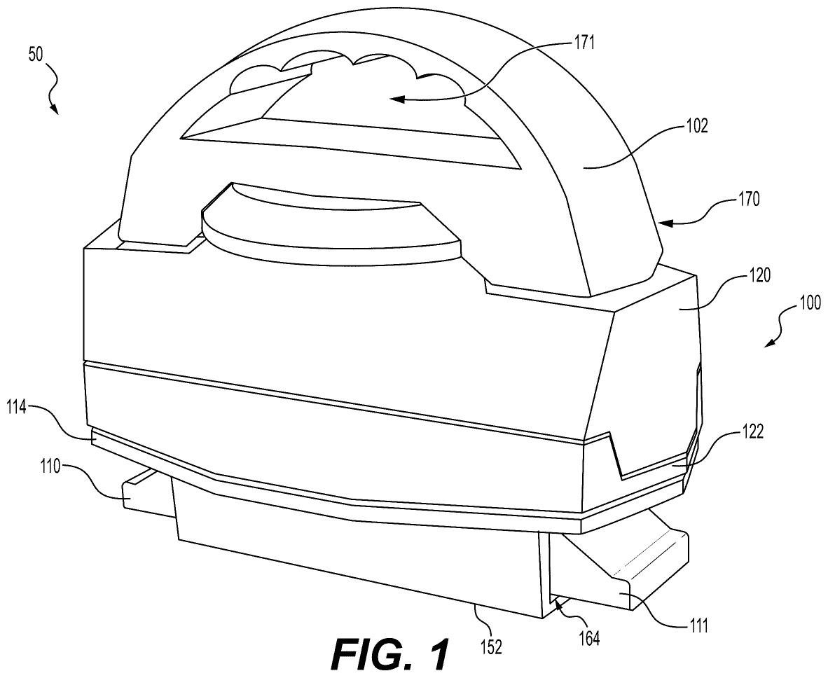

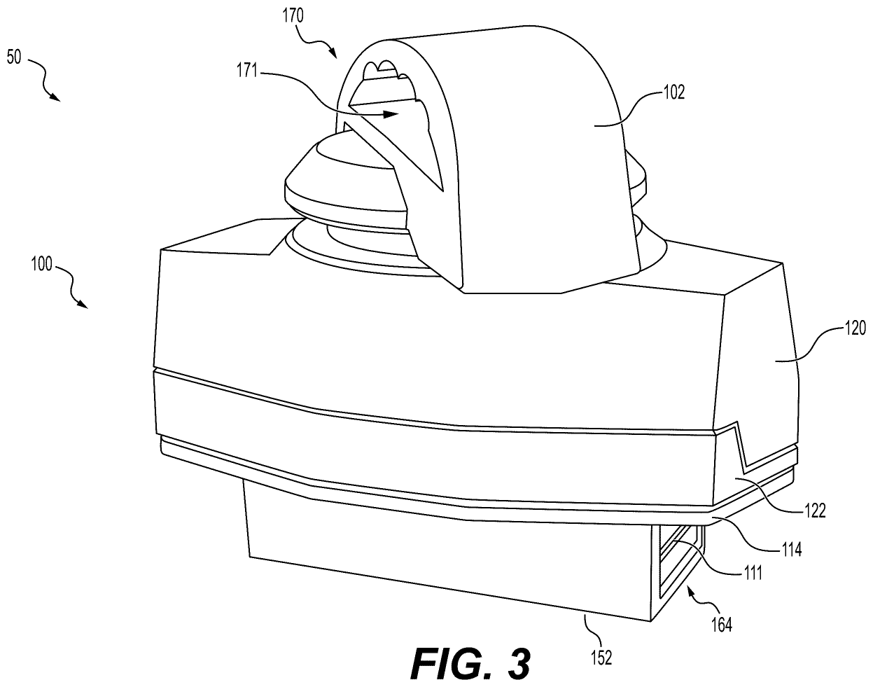

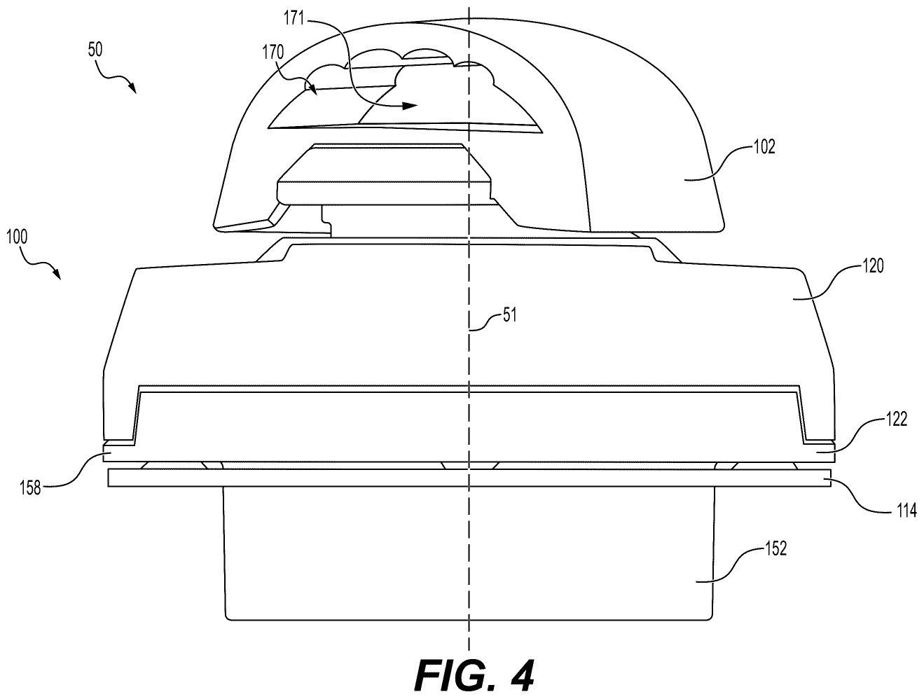

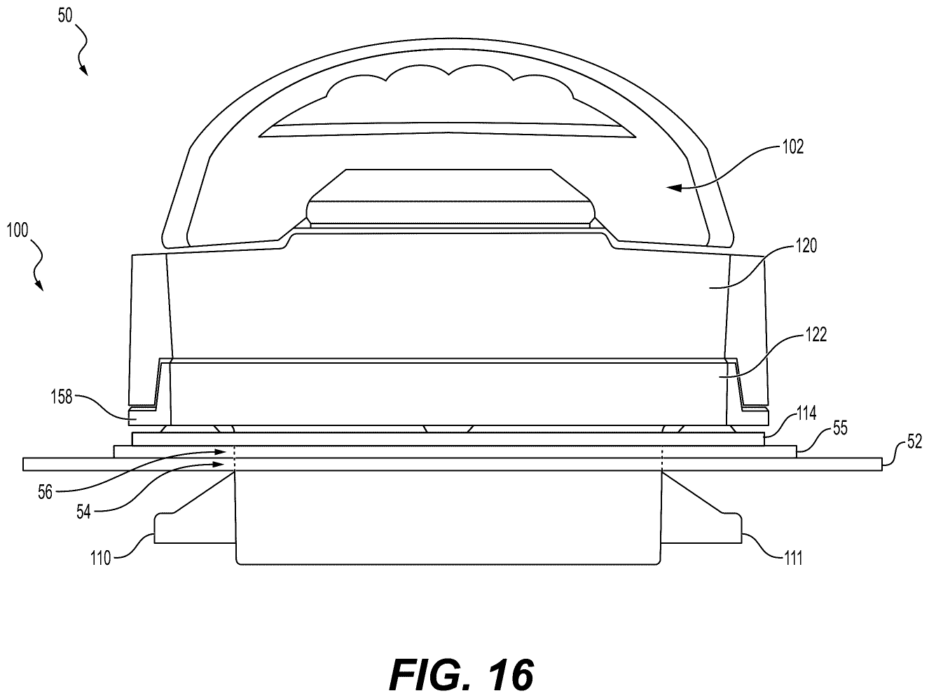

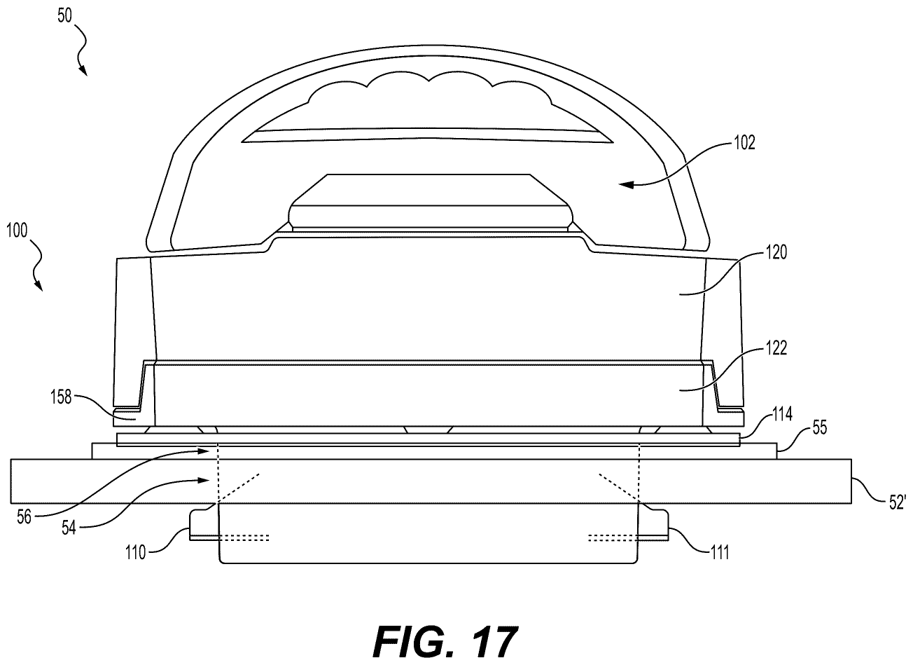

A clamping assembly 50 according to an embodiment of the present technology is shown in the accompanying Figures. As will be described in greater detail below, the clamping assembly 50 is moveable between a clamped state (FIGS. 1, 2 and 16), a plurality of intermediate clamped states (one of the intermediate clamped states being shown in FIG. 17), and an unclamped state (FIGS. 3 and 4). When in the clamped or intermediate clamped states, the clamping assembly 50 is configured to connect an accessory 55 to a connecting interface 52 (shown in FIG. 16), where the connecting interface 52 defines an aperture 54 configured to receive part of the clamping assembly 50 therethrough, and the accessory 55 defines an aperture 56 configured to receive part of the clamping assembly 50 therethrough.

In some embodiments, the clamping assembly 50 may be configured to clamp onto two or more different connecting interfaces 52. In such embodiments, one of the two connecting interfaces 52 may be disposed on a front portion of the vehicle, and another one of the two connecting interfaces 52 may be disposed on a rear portion of the vehicle. In yet other embodiments, the two or more connecting interfaces 52 may be disposed on two different vehicles. In some embodiments, the connecting interface 52 may be disposed on an accessory or on a bracket instead of on the vehicle itself. In some embodiments, the two or more connecting interfaces 52 may differ from one another. For example, and as will be described in greater detail below, one of the two connecting interfaces 52 may be thicker or thinner than the other one of the connecting interfaces 52. As will be described below, the clamping assembly 50 is a quick-action clamping assembly 50 that can automatically adjust to different connecting interfaces 52, where said different connecting interfaces may have vary in thickness from one another.

In some embodiments, the clamping assembly 50 may be selectively connected to the accessory 55. In other embodiments, the clamping assembly 50 may be integrated with the accessory 55. In some embodiments, there could be two or more clamping assemblies 50 connected to a given accessory 55 for connecting the given accessory 55 to the connecting interface 52. Various accessories are contemplated. The accessory 55 may be, without being limited thereto, a storage case, a toolbox, a light fixture, a bag, a rack, a gas tank, a gun case, a camera, a chainsaw, a shovel. In some embodiments, the accessory 55 and the mounting clamp 50 could be provided as a kit. Some instances of the accessories and their connection to connecting interfaces are described in U.S. Patent Application Publication No. 20240116459, the entirety of which is incorporated by reference herewith.

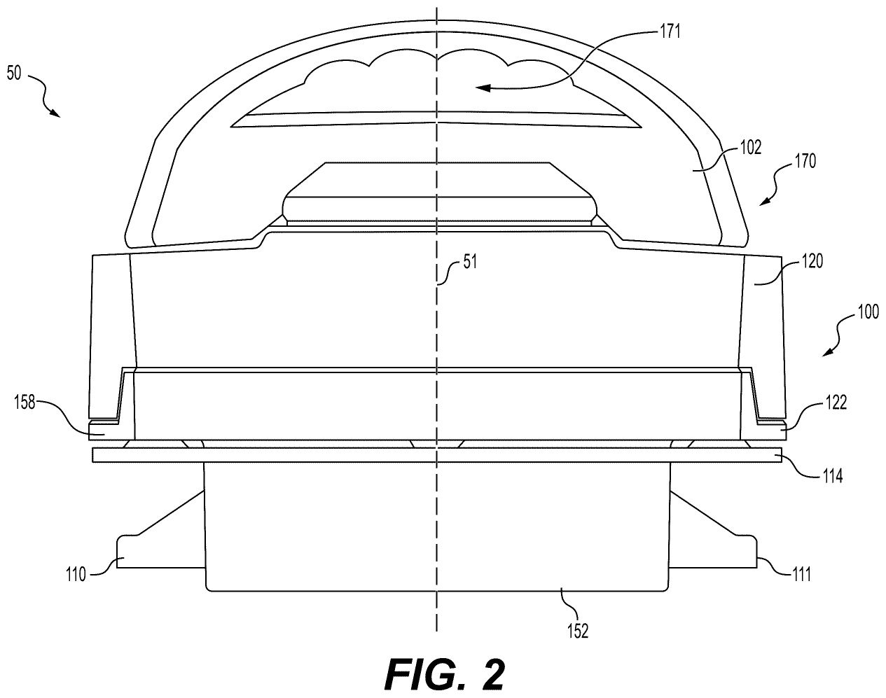

In the context of the present description, “outwardly” or “outward” means away from a longitudinal center plane 51 (shown in FIGS. 2 and 4) of the clamping assembly 50, and “inwardly” or “inward” means toward the longitudinal center plane 51. In addition, “longitudinally” means in a direction parallel to the longitudinal center plane 51, “laterally” means in a direction perpendicular to the longitudinal center plane 51 along a width of the clamping assembly 50, and “vertically” means in a direction contained in the longitudinal center plane 51 along a height direction of the clamping assembly 50. It is contemplated that during use, the clamping assembly 50 may be oriented differently from the orientation shown in accompanying Figures. For example, the clamping assembly 50 could be connected to the connecting interface 52 such that the longitudinal center plane 51 is parallel with the ground surface.

The clamping assembly 50 includes a housing 100, an actuating member 102, a compression spring 104, a guiding member 106, a torsional spring 108, two clamping members 110, 111 and a resilient membrane 114.

The housing 100 includes an upper housing portion 120 and a lower housing portion 122. The upper and lower housing portions 120, 122 are fixedly connected to one another via fasteners 124. It is contemplated that in other embodiments, the upper and lower housing portions 120, 122 could be connected to one another differently, for example via an adhesive. In some embodiments, the upper and lower housing portions 120, 122 may be provided with complementary features, which can facilitate connection therebetween, and/or can reduce likelihood of accidental disconnection therebetween. In some instances, the complementary features can form, for example, a dovetail joints or a tongue and groove joint.

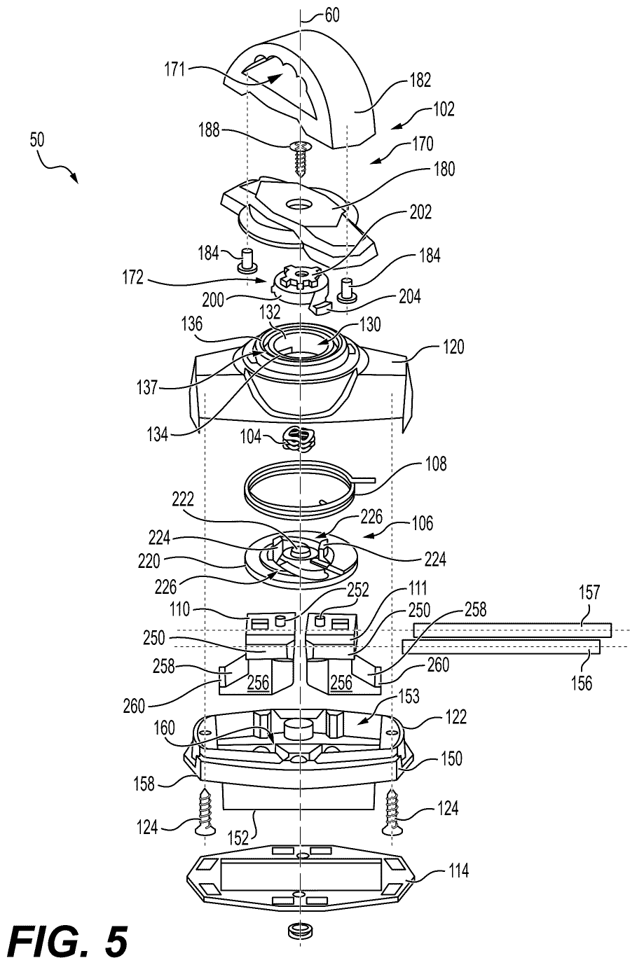

Referring to FIGS. 5 to 7, the upper housing portion 120 defines a central aperture 130. More specifically, the upper housing portion 120 has an inner radial wall 132 that defines the central aperture 130. The upper housing portion 120 has an inner upper projection 134 and an outer upper projection 136, both of which extend upwardly from an upper surface of the upper housing portion 120. The inner upper projection 134 surrounds the central aperture 130, such that the inner upper projection 134 has an annular shape. The outer upper projection 136 is disposed radially outwardly from the inner upper projection 134 and surrounds the inner upper projection 134, such that the outer upper projection 136 also has an annular shape. The inner and outer upper projections 134, 136 define radially therebetween an upper annular recess 137. The inner and outer upper projections 134, 136 may be omitted and/or may be shaped differently (e.g., could include a plurality of arcuate sections instead of being continuous annular structures). As will be described below, the inner and outer upper projections 134, 136 and the upper annular recess 137 are configured to engage with the actuating member 102 for guiding movement thereof relative to the housing 100.

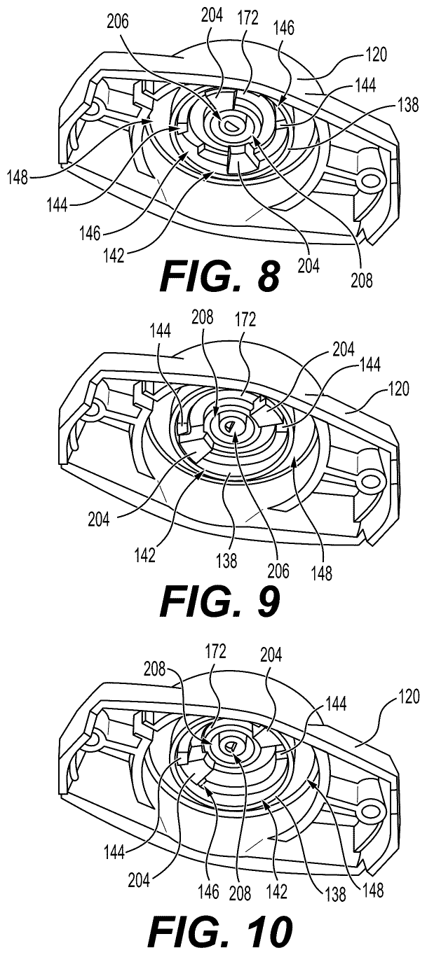

The upper housing portion 120 further has, on a bottom side thereof, a lower projection 138. The lower projection 138 is shaped such that the central aperture 130 has an upper aperture section 140 and a lower aperture section 142. Thus, the central aperture 130 can be said to be a counterbore aperture 130. The upper aperture section 140 defines a diameter D1, the lower aperture section 142 defines a diameter D2. The diameter D1 is smaller than the diameter D2. The upper housing portion 120 also has stoppers 144 (best seen in FIGS. 8 and 9) that extend radially inward and vertically within the lower aperture section 142. The stoppers 144 are disposed generally opposite to one another (i.e., disposed generally at 180 degrees from one another). Additionally, the upper housing portion 120 defines, adjacent to the stoppers 144, recesses 146 that extend radially and vertically (i.e., into the lower projection 138). The recesses 146 are also disposed opposite to one another (i.e., disposed generally at 180 degrees from one another). As will be described below, the stoppers 144 and the recesses 146 are configured to engage with the actuating member 102. Still at a bottom thereof, the upper housing portion 120 defines, radially outwardly from the lower projection 138, a containing recess 148. The containing recess 148 is in part defined by the lower annular projection 138, and, as will be described below, is configured to contain the torsional spring 108 therein.

Referring to FIGS. 5 to 7 and 11, the lower housing portion 122 has an upper part 150 and a lower part 152 extending downwardly from the upper part 150. The upper and lower parts 150, 152 are integral, but it is contemplated that in other embodiments, the lower housing portion 122 may be made of two or more parts connected to one another.

The upper part 150 extends all around and beyond the lower part 152, such that the upper part 150 has a larger perimeter than the lower part 152.

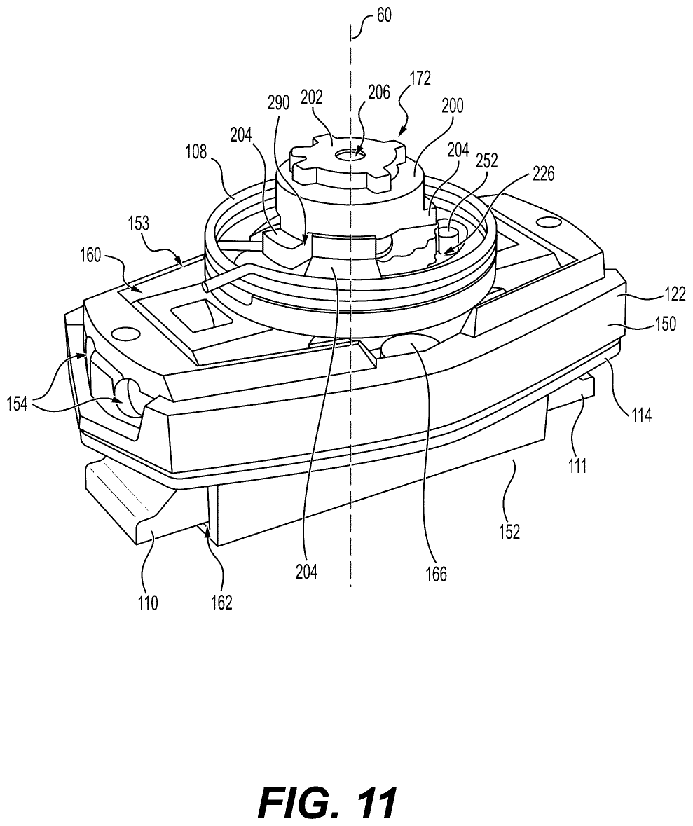

The upper part 150 defines, at a top thereof, an opening 153 via which, as will described below, members of the clamping assembly 50 can interact with one another. Additionally, the upper part 150 defines, on each lateral side thereof, apertures 154 (shown in FIG. 11). The apertures 154 are configured to receive guiding portions 156, 157, which will also be described below. At a bottom thereof, the upper part 150 defines a clamping surface 158 that surrounds the lower part 152. The clamping surface 158 is generally flat. The clamping surface 158 is configured to engage a surface of the connecting interface 52 or to engage the resilient membrane 114. Accordingly, the clamping surface 158 may be referred to, in some instances, as an engaging surface and/or an abutting surface.

The lower part 152 defines an interior zone 160 configured to receive at least part of the clamping members 110, 111 therein. A bottom of the interior zone 160 is defined by a bottom platform 161. As will be described below, in some instances, the clamping members 110, 111 rest on the bottom platform 161, and are slideable thereon. The lower part 152 further defines an opening 162 (FIG. 11) on one lateral side thereof, and an opening 164 (FIGS. 1 and 3) on the other lateral side thereof. As will be described below, the openings 162, 164 are configured to receive, respectively, parts of the clamping members 110, 111 therethrough. The lower part 152 also has, within the interior zone 160, stoppers 166. The stoppers 166 are longitudinally aligned with one another, and are laterally centered in the interior zone 160 with respect to the lower part 152. The stoppers 166 stop movement of each of the clamping members 110, 111 when each of the clamping members 110, 111 reaches a retracted position. The stoppers 166 may be omitted in some embodiments.

The housing 100 also includes the guiding portions 156, 157 which are configured to guide movement of the clamping members 110, 112. The guiding portions 156, 157 are disposed in the lower housing portion 122. More specifically, each one of the guiding portions 156, 157 is received in one aperture 154 defined on one lateral side of the upper part 150 and a corresponding aperture 154 defined on the other lateral side of the upper part 150. Thus, the guiding portions 156, 157 are sized to extend laterally along an entire width of the upper segment 150. It is contemplated that in other embodiments, there could be a single guiding portion or three or more guiding portions. Additionally, while the guiding portions 156, 157 are illustrated as each having a cylindrical shape, it is contemplated that the guiding portions 156, 157 may be shaped differently (e.g. one or both of the guiding portions 156, 157 could have a prismatic shape). It is further contemplated that in some embodiments, the guiding portions 156, 157 could be provided as slots and/or rails. Additionally, in some embodiments, the guiding portions 156, 157 could be integral with the lower housing portion 122, or be connected to the lower housing portion 122 without requiring the apertures 154.

Referring to FIGS. 5 to 11, the actuating member 102 will now be described in greater detail. The actuating member 102 is partially received in the housing 100 and is moveable relative thereto. As will be described in greater detail below, the actuating member 102 is rotatable about a rotation axis 60, and is moveable along the rotation axis 60. The rotation axis 60 is generally disposed at a longitudinal and lateral center of the actuating member 102 (and thus of the clamping assembly 50), and is contained in the longitudinal center plane 51. The actuating member 102 includes a handle portion 170 and an actuating portion 172. In some embodiments, the handle portion 170 and the actuating portion 172 could be considered to be distinct members.

The handle portion 170 includes a base portion 180 and a cover portion 182. The base and cover portions 180, 182 are selectively connected to one another via fasteners 184. It is contemplated that in other embodiments, the base and cover portions 180, 182 could be connected to one another differently, for example via an adhesive. In some embodiments, the base and cover portions 180, 182 could be integral with one another. In yet other embodiments, the cover portion 182 could be omitted. The handle portion 170 defines an aperture 171 shaped to receive fingers therein. It is contemplated that the aperture 171 may be shaped differently. It is also contemplated that the handle portion 170 may be shaped differently. For example, the handle portion 170 could be a T-shaped handle, a knob, a lever or a button.

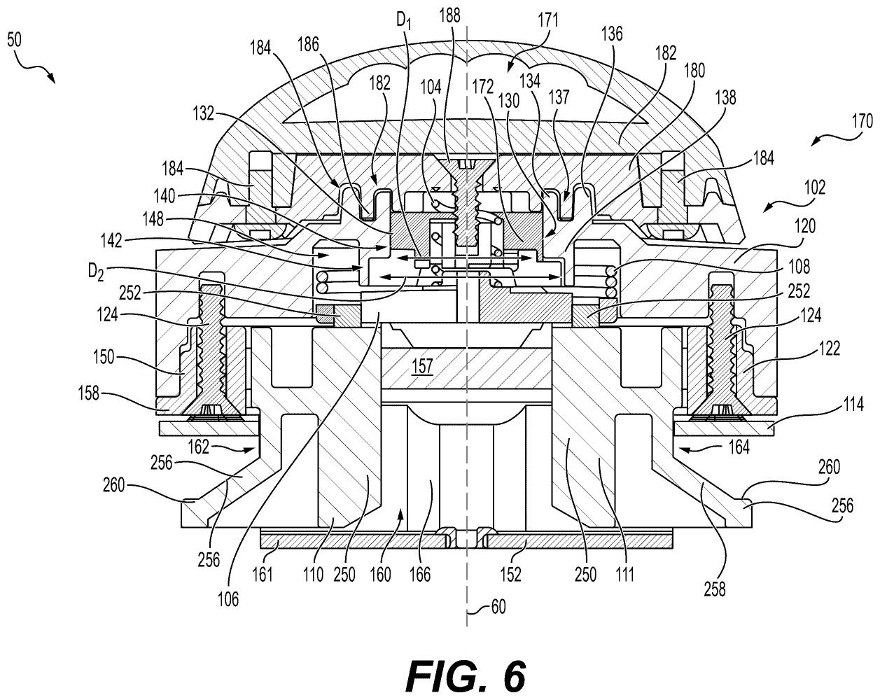

Best seen in FIG. 6, the base portion 180 defines, on a bottom side thereof, an inner annular recess 182 and an outer annular recess 184. The inner and outer annular recesses 182, 184 are separated by an annular projection 186. The housing 100 and the actuating member 102 are configured such that, in some instances, the inner annular recess 182 receives the inner upper projection 134 of the upper housing portion 120, the outer annular recess 184 receives the outer upper projection 136 of the upper housing portion 120, and the annular projection 186 is received in the annular recess 137 of the upper housing portion 120. This configuration can assist in guiding a rotational movement of the handle portion 170 (and thus of the actuating member 102) relative to the housing 100.

The base portion 180 is further fixedly connected to the actuating portion 172 via a fastener 188. It is contemplated that in other embodiments, the base portion 180 may be connected to the actuating portion 172 differently. In some embodiments, the base portion 180 may be integral with the actuating portion 172.

Thus, due to the connection between the base portion 180 and the actuating portion 172, the handle portion 170 and the actuating portion 172 are fixedly connected to one another such that in response to the handle portion 170 rotating about the rotation axis 60 relative to the housing 100, the actuating portion 172 rotates about the rotation axis 60 relative to the housing 100, and vice-versa.

As best seen in FIG. 11, the actuating portion 172 has a body 200. The body 200 has, extending from a top thereof, an engaging portion 202. The engaging portion 202 has a particular shape that is complementary to a recess defined on an underside of the base portion 180. The particular shape can assist in providing a secure connection between the actuating portion 172 and the base portion 180, such that rotation of one causes rotation of the other (and thus securely connecting the actuating portion 172 and the handle portion 170). Additionally, during assembly of the actuating portion 172 with the base portion 180, the engaging portion 202 can ensure that the base portion 180 and the actuating portion 172 are in the correct orientation with respect to one another. The body 200 further has, at a bottom thereof, two actuating engaging portions 204. The actuating engaging portions 204 are tabs 204, and will henceforth be referred to as such. The tabs 204 are positioned opposite to one another (i.e., generally spaced 180 degrees from one another), and are, as will be described in greater detail below, configured to be received in corresponding recesses 146 of the upper housing portion 120 when the actuating member 102 is in a restricted configuration (shown in FIG. 10). The body 200 and the tabs 204 are sized such that the body 200 can fit into the upper aperture section 140 of the central aperture 130 (i.e., a diameter of part of the body 200 is smaller than a diameter of the upper aperture section 140). However, the tabs 204 are too large to fit into the upper aperture section 140 (i.e. a diameter of the tabs 204 is greater than a diameter of the upper aperture section 140). The body 200 and the tabs 204 are sized to fit in the lower aperture section 142. It is contemplated that in some embodiments, the number of tabs 204, and thus the number of recesses 146 may vary from one embodiment to another. The actuating portion 172 further defines, at a center thereof, an aperture 206 that is configured to receive the fastener 188 therein. In the present embodiment, the aperture 206 is defined through the engaging portion 202 and through the entire height of the body 200, though this may change from one embodiment to another. The body 200 further defines, at an underside thereof, an annular recess 208. The annular recess 208 is disposed radially outwardly from the aperture 206. The interior annular recess 208 is configured to receive part of the compression spring 104 therein.

As mentioned above, the actuating member 102 is moveable relative to the housing 100. In more detail, the actuating member 102 is moveable along the rotation axis 60 between an unrestricted configuration (best seen in FIGS. 8 and 9) and the restricted configuration (best seen in FIG. 10). When the actuating member 102 is in the unrestricted configuration, the actuating member 102 is rotatable about the rotation axis 60 between an extending actuating position (FIGS. 1, 2 and 6) and a retracting actuating position (FIGS. 3, 4 and 7). The extending and retracting actuating positions are thus rotational positions. When the actuating member 102 is in the restricted configuration, the actuating member 102 is generally rotationally fixed with respect to the housing 100.

When the actuating member 102 is in the restricted configuration, the actuating member 102 is positioned higher with respect to the housing 100, in a heightwise direction of the clamping assembly 50, than when the actuating member 102 is in the unrestricted configuration.

When the actuating member 102 is in the restricted configuration, the actuating member 102 is in the retracting actuating position, such that the tabs 204 of the actuating portion 172 are generally aligned with corresponding recesses 146. Because the actuating member 102 is in a raised position relative to the housing 100, the tabs 204 are received in the corresponding recesses 146. The engagement between the tabs 204 and the housing 100 results in the actuating member 102 not being rotatable about the rotation axis 60.

When the actuating member 102 is in the unrestricted configuration, the actuating member 102 is moveable between the retracting actuating position and the extending actuating position. Because the actuating member 102 is in a lowered position relative to the housing 100, the tabs 204 are not received in the recesses 146, such that actuating member 102 is rotatable about the rotation axis 60. However, as will be described in greater detail below, the torsional spring 108 biases the actuating member 102 toward the extending actuating position.

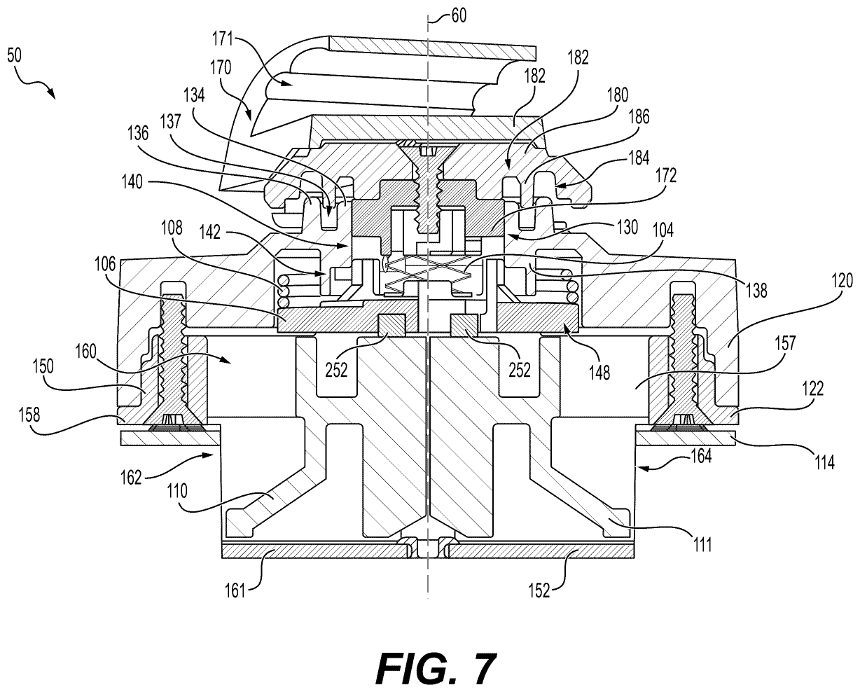

Referring to FIGS. 6 and 7, the compression spring 104 is received in the interior annular recess 208. One end of the compression spring 104 abuts an upper wall of the body 200, where the upper wall defines an upper end of the interior annular recess 208. The other end of the compression spring 104 abuts the guiding member 106. It is contemplated that in other embodiments, the compression spring 104 could be another biasing member 104 such as a polymeric member 104. The compression spring 104 is configured to bias the actuating member 102 toward the raised position, thus toward the restricted configuration.

Referring to FIGS. 5, 6, 7 and 11 to 14, the guiding member 106 will now be described in greater detail. The guiding member 106 is operationally engaged to the actuating member 102 and to the clamping members 110, 111. The guiding member 106 has a body 220 that is generally shaped like a disc. On an upper surface thereof, the body 220 has a raised portion 222. The raised portion 222 is generally centered on the body 220, and engages with the compression spring 104. More specifically, the raised portion 222 is sized to be partially received in the compression spring 104, and can assist in limiting likelihood of buckling of the compression spring 104. The guiding member 106 also has two guide engaging portions 224. The guide engaging portions 224 are radially spaced from the raised portion 222 and are disposed generally opposite to one another (i.e., generally 180 degrees from one another). The guide engaging portions 224 are engageable with the tabs 204 of the actuating member 102. As will be described below, in response to the actuating member 102 being rotated, the tabs 204 can engage with the guide engaging portions 224, which causes the guiding member 106 to rotate about the rotation axis 60. The guiding member 106 also defines two slots 226. It is contemplated that in some embodiments, there could be only one slot. Each of the slots 226 is arcuate about a respective point P that is offset from the rotation axis 60. Thus, each slot 226 extends radially away from the rotation axis, and generally circumferentially about the point P. Additionally, each one of the slots 226 defines a plurality of retaining recesses 228. The retaining recesses 228 are defined on a radially inner side of the slots 226, whereas the radially outer side of the slots are generally smooth. As will be described below, some of the retaining recess 228 corresponds to an intermediate clamped state.

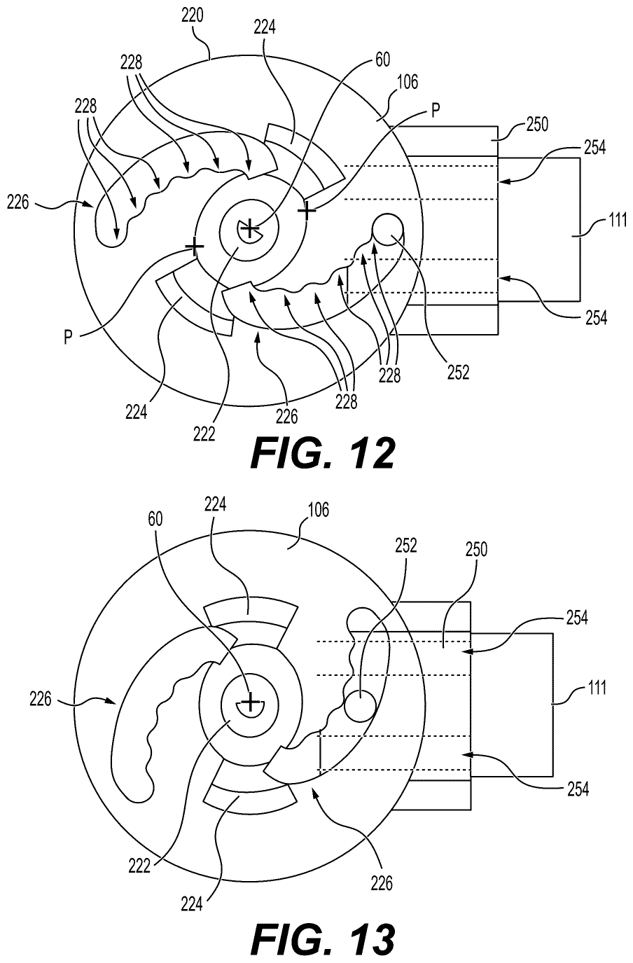

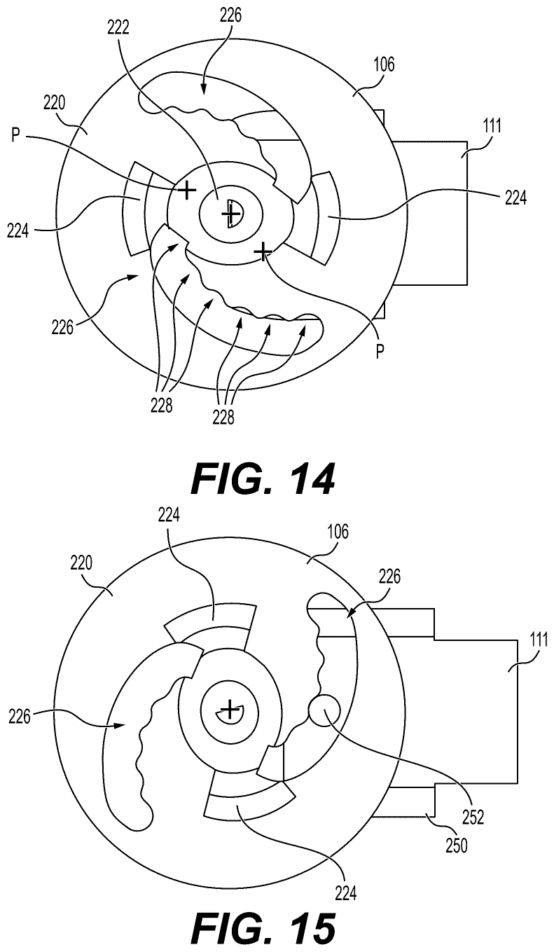

As mentioned above, the guiding member 106 is rotatable about the rotation axis 60 between a retracting guide position (best seen in FIG. 14) and an extending guide position (best seen in FIG. 12). The retracting and extending guide positions are thus rotational positions.

The torsional spring 108 is connected to the upper housing portion 120 and to the guiding member 106. In more detail, the torsional spring 108 is received in the containing recess 148 (best seen in FIGS. 6 and 7). The torsional spring 108 has one end fixedly connected to the upper housing portion 120, and another end fixedly connected to the guiding member 106. The torsional spring 108 biases the guiding member 106 towards the extending guide position. As will be described below, the guiding member 106 being biased toward the extending guide position, can in turn, bias the actuating member 102 toward the extending actuating position. In the present embodiment, the torsional spring 108 is a torsional spring, but other biasing members, such as a polymeric member, are contemplated.

Referring to FIGS. 5 to 7 and 11, the left and right clamping members 110, 111 are disposed in the housing 100. More specifically, the left and right clamping members 110, 111 are mostly disposed in the interior zone 160 of the lower housing portion 122, and rest on the bottom platform 161. As will be described in greater detail below, the clamping members 110, 111 are moveable between an extended position (shown in FIGS. 1, 2 and 6) and a retracted position (shown in FIGS. 3, 4 and 7). It is contemplated that in some embodiments, there could only be a single clamping member or three or more clamping members. As the left and right clamping members 110, 111 are the same, only the clamping member 110 will be described in detail herewith.

The clamping member 110 has a body 250. At a top thereof, the body 250 has a clamping engager 252. The clamping engager 252 is cylindrical protrusion that is integral with the body 250. It is contemplated that the clamping engager 252 could be shaped differently. The clamping engager 252 may also be connected to the body 250. As will be described below, the clamping engager 252 is operationally engaged to the guiding member 106 by being received in one of the slots 226. The body 250 defines two apertures 254. The two apertures 254 are longitudinally spaced from one another, and are through apertures that extend in the lateral direction. Each one of the apertures 254 receives a corresponding one of the guiding portions 156, 157. As will be described below, as the clamping member 102 moves between the retracted and extended positions, the movement thereof is guided by the guiding portions 156, 157. The body 250 further has a clamping portion 256. The clamping portion 256 extends laterally and vertically so as to have an inclined surface 258. The clamping portion 256 can thus be said to be a tapered clamping portion and/or can be said to have a generally triangular shape. As will be described below, the inclined surface 258 enables the clamping assembly 50 to connect to connecting interfaces 52 of varying sizes and/or thicknesses. The clamping portion 256 further has a flat surface 260 at a lower end thereof.

When the clamping members 110, 111 are in their extended positions, the clamping member 110 extends from opening 162, out of the interior zone 160, and the clamping member 111 extends from the opening 164, out of the interior zone 160.

When the clamping members 110, 111 are in their retracted positions, the clamping members 110, 111 are fully received in the housing 100, more specifically in the interior zone 160, and generally do not extend out of the respective openings 162, 164.

The resilient membrane 114 has define an aperture 280 that is configured to receive the lower part 152 therethrough. The resilient membrane 114 is further generally shaped to cover the clamping surface 158. The resilient membrane 114 is made from a polymeric material, and is resiliently deformable. As will be described below, the resilient membrane 114 can assist in enhancing a clamping effect of the clamping assembly 50 (e.g., by applying a pre-load), and can further prevent scratching to the clamping surface 158 and/or to the connecting interface 150. It is to be noted that in some embodiments, the resilient membrane 114 may be omitted from the clamping assembly 50. In other embodiments, the resilient membrane 114 may be integrated with the accessory 55 and/or with the connecting interface 52.

Referring to FIGS. 1, 2, 6, 11 and 12, the clamping assembly 50 is shown in the clamped state. In the clamped state, the actuating member 102 is in the unrestricted configuration (i.e., in the lowered position), and in the extending actuating position. In this embodiment, the handle portion 170 is generally aligned with the upper housing portion 120. This can assist in providing a visual indication that the clamping assembly is in the clamped state. Since the actuating member 102 is in the lowered position, the compression spring 104 is resiliently deformed, and biases the actuating member 102 towards the raised position. However, since the tabs 204 are not aligned with the recesses 146, the tabs 204 abut against the lower projection 138 and prevent the actuating member 102 from returning to the raised position. The guiding member 106 is in the extending guide position. In the present embodiment, when the actuating member 102 is in the extending actuating position and the guiding member 106 is in the extended guide position, the tabs 204 of the actuating member 102 are spaced from the guide engaging portions 224 they are configured to engage with. Thus, a gap 290 is defined between each tab 204 and its corresponding guide engaging portion 224. It is contemplated that in some embodiments, the gap 290 may be omitted. Furthermore, the clamping members 110, 111 are in their extended positions. Thus, the clamping engagers 252 of the clamping members 110, 111 are disposed at a radial outer end of their corresponding slots 226.

Referring to FIGS. 3, 4, 7, 10 and 14, the clamping assembly 50 is shown in the unclamped state. In the unclamped state, the actuating member 102 is in the restricted configuration (i.e., in the raised position), and in the retracting actuating position. In this embodiment, the handle portion 170 is rotationally offset from the upper housing portion 120. This can assist in providing a visual indication that the clamping assembly 50 is in the unclamped state. The tabs 204 of the actuating portion 172 are rotationally aligned with, and received in, the recesses 146. The guiding member 106 is in the retracting guide position. When the actuating member 102 is in the retracting actuating position and the guiding member 106 is in the retracting guide position, the actuating member 102 and the guiding member 106 are still in engagement with one another via the tabs 204 and the engaging portions 204. The rotational spring 108 is resiliently deformed, and biases the guiding member 106 towards the extending guide position. However, since the actuating member 102 is rotationally fixed relative to the housing 100, the actuating member 102 prevents the guiding member 106 from rotating to the extending guide position. The clamping member 110, 11 are in their retracted position. Thus, the clamping engagers 252 of the clamping members 110, 111 are disposed at a radial inner end of their correspond slots.

The clamping assembly 50 as it moves from the unclamped state to the clamped state to clamp onto the connecting interface 52 will now be described.

With the clamping assembly 50 being in the unclamped state, the clamping assembly 50 can partially be received through the aperture 54 of the connecting interface 52. More specifically, the clamping members 110, 111 are in their retracted positions, so the lower part 152 can be received in the aperture 54 without the clamping members 110, 111 abutting the connecting interface 52 (i.e., the clamping members 110, 111 not projecting from the openings 162, 164 make it possible for the lower part 152 to be received through the aperture 54).

When the clamping assembly 50 is disposed on the connecting interface 52, the resilient membrane 114 is disposed between the clamping surface 158 and an upper surface of the connecting interface 52. The clamping assembly 50 can then be moved to the clamped state. The connecting interface 52 is sized such that the clamping assembly 50 will reach the clamped state. As will be described below, if the connecting interface 52 were to have a thickness greater than a predetermined thickness, the clamping assembly 50 could instead reach an intermediate clamping state.

To move the clamping assembly 50 to the clamped state, the actuating member 102 is moved to the unrestricted configuration by moving the actuating member 102 to the lowered position. This can be achieved by applying an external downward force on the handle portion 170 (i.e., along the rotation axis 60), where the downward force is greater than the biasing force of the compression spring 104. When the actuating member 102 is in the unrestricted configuration, as mentioned above, the actuating member 102 can rotate relative to the housing 100 about the rotation axis 60. However, since the actuating portion 172 is engaged to the guiding member 106 via the tabs 204 and the guide engagement portions 224, and the guiding member 106 is biased toward the extending guide position due to the torsional spring 108, once the actuating member 102 is in the unrestricted configuration, the actuating member 102 move toward the extending actuating position. Additionally, as the guiding member 106 rotates toward the extending guide position, the clamping members 110, 111 are guided toward their extended positions. More specifically, the guiding member 106 acts like a cam, and its rotational movement causes the clamping members 110, 111 to move in a linear fashion. The clamping engagers 252 abut an edge of the slots 226, which causes the clamping members 110, 110 to move. The clamping members 110, 111 move linearly in part due to the shape of the slots 226, and due to the guiding portions 156, 157. In some instances, the clamping members 110, 111 reach their extended positions faster due to the slots 226 being arcuate about the point P, than if the slots 226 were not arcuate about the point P. Since the connecting interface 52 is sized such that the clamping assembly 50 reaches its clamped state, the clamping engagers 252 are received in the radially furthest retaining recess 228. The radially furthest retaining recess 228 corresponds to the clamped state, and other retaining recesses 228 correspond to intermediate clamped states. The clamping engagers 252 being received in the retaining recesses 228 can prevent the clamping members 110, 111 from being moved toward the retracted positions by applying a force thereon, where the force is applied toward the clamping members 110, 111 (i.e., generally perpendicular to the longitudinal central plane 51).

It will be appreciated that in response to the actuating member 102 moving to the unrestricted configuration (i.e., by pressing down on the handle portion 170), the clamping assembly 50 “automatically” moves to the clamping state, without requiring any special tools. The movement of the clamping assembly 50 from the unclamped state to the clamped state also happens quickly, without needing to perform any manual adjustment once the clamping assembly 50 is in the clamped state. The clamping assembly 50 can thus be referred to a quick-attach clamping assembly 50.

In the clamped state, as shown in FIG. 16, once the clamping members 110, 111 project from their respective openings 162, 164, a top of the inclined surfaces 258 of the clamping portions 256 engage a bottom surface of the connecting interface 52. Thus, a clamping effect is applied between the clamping surface 158 and the clamping members 110, 111. The resilient membrane 114 is thus resiliently deformed between the clamping surface 158 and the upper surface of the connecting interface 152, which can enhance the clamping by applying also applying a biasing force due to its resilient nature. Additionally, in some instances, the resilient membrane 114 can assist in distributing pressure more evenly.

To unclamp the clamping assembly 50 from the connecting interface 52 (i.e., to move the clamping assembly 50 to the unclamped state), the actuating member 102 is moved toward the retracting actuating position. This can be achieved by rotating the actuating member 102 via the handle portion 170 with a force sufficient to overcome the biasing force applied by the torsional spring 108, until the actuating member 102 reaches the retracting actuating position. Additionally, due to the gap 290 present between the tabs 204 and the guide engaging portions 224, initially, the rotation of the actuating member 102 does not cause retraction of the clamping members 110, 111, instead the gaps 290 between respective tabs 204 and guide engaging portions 224 are closed. This can assist in reducing likelihood of accidental unclamping.

Eventually, when the actuating member 102 reaches the retracting actuating position, the compression spring 104 causes the actuating member 102 to move to the raised position (i.e., to the restricted configuration) without requiring the user to manually raise actuating member 102. As mentioned above, when the actuating member 102 is in the restricted configuration, the actuating member 102 and the guiding member 106 are rotationally fixed relative to the housing 100.

As the guiding member 106 is rotating about the rotation axis 60, the clamping members 110, 111 are caused to move toward their retracted positions, due to the engagement between the clamping engagers 252 and the slots 226. The movement of the clamping members 110, 111 toward their retracted positions is generally smooth because as shown in FIG. 13, when the clamping members 110, 111 are moving toward their retracted position, the clamping engagers 252 abut the smooth side of the slots 226.

With reference to FIG. 17, the clamping assembly 50 is connected to a connecting interface 52′. The connecting interface 52′ is thicker than the connecting interface 52. In this situation, the clamping assembly 50 moves to an intermediate clamped state due to the thickness of the connecting interface 52. Thus, when the actuating member 102 is moved from the restricted configuration to the unrestricted configuration, the actuating member 102 rotates until the inclined surfaces 258 of the engaging portions 256 engage the bottom surface of the connecting interface 52. Thus, the clamping members 110, 111 are positioned intermediate to the extended and retracted positions. Accordingly, a position of the guiding member 106 is intermediate to the retracting guide position and the extending guide position, and the actuating member 102 is intermediate to retracting actuating position and extending actuating position. In some embodiments, if the connecting interface 52′ is at a maximum thickness, the flat surface 260 engages the bottom surface of the connecting interface 52. When the inclined surfaces 258 engage the bottom surface of the connecting interface 52, the clamping engagers 252 of the clamping members 110, 112 are received in corresponding respective retaining recesses 228 of their slots 226.

It will be appreciated that despite a variation in thickness between the connecting interface 52 and the connecting interface 52′, a clamping effect applied by the clamping assembly 50 remains generally similar. Additionally, the clamping assembly 50 can automatically clamp onto the connecting interfaces 52, 52′ without needing to be manually adjusted to connect to different connecting interfaces.

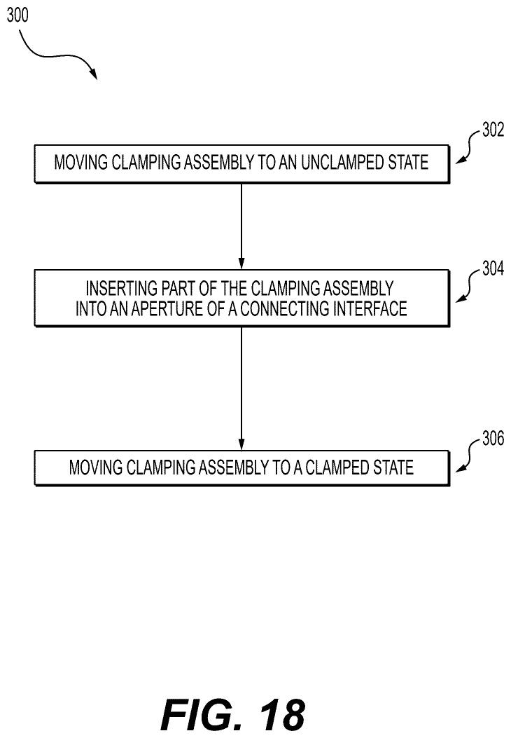

Referring to FIG. 18, a method 300 for installing the accessory 55 on the connecting interface 52 with the clamping assembly 50 will now be described.

The method begins at step 302, by moving the clamping assembly 50 to the unclamped state.

Then, at step 304, the method 300 includes inserting part of the clamping assembly 50 into the apertures 54, 56 of the connecting interface 52 and the accessory 55.

Then, at step 306, the method 300 includes moving the clamping assembly 50 to the clamped state, which clamps the accessory 55 to the connecting interface 52.

The various components of the clamping assembly 50 are made of conventional materials (e.g., metallic materials, such as steel or aluminum, non-metallic material, such as plastics, and/or composite materials) via conventional manufacturing processes (e.g., casting, molding, 3d printing, etc.). The present technology does not require any specific materials nor methods of manufacture. The present technology merely requires that each component be suitable for the purpose for which it is intended and the use to which it is to be put. Any material(s) or method(s) of manufacture which produce such components may be used in the present technology.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A clamping assembly comprising:
a housing defining an opening, and having a clamping surface;
at least one clamping member partially received in the housing, the at least one clamping member being moveable between:
an extended position, in which part of the at least one clamping member extends from the opening; and
a retracted position, in which the part of the at least one clamping member is received in the housing;
a guiding member operatively engaged to the at least one clamping member, the guiding member being rotatable about a rotation axis between:
a first guide position, in which the at least one clamping member is in the extended position; and
a second guide position, in which the at least one clamping member is in the retracted position, and
a biasing member for biasing the guiding member toward the first guide position;
an actuating member at least partially disposed in the housing, the actuating member being configured to operatively engage the guiding member in:
a first configuration, in which the actuating member is rotatable about the rotation axis between a first rotational position and a second rotational position; and
a second configuration in which the actuating member is prevented from rotating relative to the rotation axis,
with the actuating member in the first configuration, in response to the actuating member rotating between the first rotational position and the second rotational position, the operational engagement between the actuating member and the guiding member causes the guiding member to rotate between the first guide position and the second guide position; and
with the actuating member in the second configuration, the guiding member is prevented from rotating relative to the rotation axis;
the clamping assembly being moveable between:
a clamped state, in which:
the actuating member is in the first configuration, and in the first rotational position;
the guiding member is in the first guide position; and
the at least one clamping member is the extended position, and
the clamping assembly is configured to clamp onto a connecting interface by the clamping surface of the housing and the at least one clamping member,
an unclamped state, in which:
the actuating member is in the second configuration;
the guiding member is in the second guide position; and
the at least one clamping member is in the retracted position.

2. The clamping assembly of claim 1, wherein the clamping assembly is configured to move from the unclamped sate to the clamped state automatically.

3. The clamping assembly of claim 1, wherein the clamping assembly is further moveable to an intermediate clamped state, in which:
the actuating member is in the first configuration, and in a third rotational position, the third position being intermediate to the first and second rotational positions;
the guiding member is in a third guide position, the third guide position being intermediate to the first and second guide positions; and
the at least one clamping member is in an intermediate position, the intermediate position being intermediate to the extended and retracted positions, and
the clamping assembly is configured to clamp onto the connecting interface between the clamping surface of the housing and the at least one clamping member.

4. The clamping assembly of claim 3, wherein the clamping assembly is configured to move from the unclamped state to the intermediate clamped state automatically.

5. The clamping assembly of claim 1, wherein the actuating member includes a handle portion, a position of the actuating member being adjustable via the handle portion.

6. The clamping assembly of claim 1, wherein the housing includes an upper housing portion at least partially receiving the guiding member and the actuating member, and a lower housing portion defining the opening and at least partially receiving the at least one clamping member.

7. The clamping assembly of claim 1, wherein the housing has a guiding portion engaged with the at least one clamping member for guiding a movement of the at least one clamping member between the retracted and extended positions.

8. The clamping assembly of claim 7, wherein the at least one clamping member defines an aperture configured to receive the guiding portion.

9. The clamping assembly of claim 1, wherein the at least one clamping member moves between the extended and retracted positions along a linear path.

10. The clamping assembly of claim 1, wherein the at least one clamping member has a tapered clamping portion.

11. The clamping assembly of claim 1, wherein:
the at least one clamping member has a clamping engager, and
the guiding member defines a slot sized to receive the clamping engager.

12. The clamping assembly of claim 11, wherein:
with the at least one clamping member being in the extended position, and the guiding member being in the first guide position, the clamping engager is disposed at a radially inner end of the slot; and
with the at least one clamping member being in the retracted position, and the clamp guiding member being in the second guide position, the clamping engager is disposed at a radially outer end of the slot.

13. The clamping assembly of claim 11, wherein the slot is arcuate.

14. The clamping assembly of claim 13, wherein the slot is arcuate about a point offset from the rotation axis.

15. The clamping assembly of claim 11, wherein the slot defines a first retaining recess and a second retaining recess, the first and second retaining recesses being configured to at least partially receive the clamping engager therein for preventing movement of the at least one clamping member toward the retracted position in response to an external force being applied on the at least one clamping member,
with the guiding member being in the first guide position, the clamping engager is received in the first retaining recess; and
with the guiding member being in the second guide position, the clamping engager is received in the second retaining recess.

16. The clamping assembly of claim 1, wherein the guiding member is a cam.

17. The clamping assembly of claim 1, wherein:
the guiding member has a guide engaging portion,
the actuating member has an actuating engaging portion,
in response to the guiding member moving from the first rotational position to the second rotational position, the guide engaging portion engages the actuating engaging portion for causing the guiding member to move from the first guide position to the second guide position.

18. The clamping assembly of claim 17, wherein with the guiding member being in the first guide position, the actuating member being in the first rotational position, the guide and actuating engaging portions are rotationally spaced from one another for providing some play between rotation of the actuating member, and rotation of the actuating member.

19. The clamping assembly of claim 1, wherein the biasing member is operatively connected to housing and to the guiding member.

20. The clamping assembly of claim 1, wherein the biasing member is a first biasing member, and the clamping assembly further includes a second biasing member operatively connected to the actuating member for biasing the actuating member toward the second configuration.
